(19) United States
(12) Patent Application Publication
(10) Pub. No.: US 2006/0059001 A1
(43) Pub. Date: Mar. 16, 2006

(54) Method of embedding sound field control factor and method of processing sound field

(76) Inventor: Byeong-seob Ko, Suwon-si (KR)

Correspondence Address: STANZIONE & KIM, LLP, 919 18TH STREET, N.W., SUITE 440, WASHINGTON, DC, 20006, US

(21) Appl. No.: 11/100,446

(22) Filed: Apr. 7, 2005

(30) Foreign Application Priority Data
Sep. 14, 2004 (KR) 2004-73367

(51) Int. Cl. G10L 17/00

(52) U.S. Cl. 704/273

(57) ABSTRACT

A method of embedding sound field control factors (SFC factors) into a sound source. The method includes coding sound field factors and sound field information to obtain sound field control factors for the sound source in a binary data type, and the sound field factors represent an acoustic characteristic of the sound source and the sound field information represents an environment under which the sound source is decoded, and watermarking the sound field control factors into the sound source without compressing the sound source. In this method, the SFC factors that represent characteristics of the sound source are embedded into the sound source itself using a digital watermarking technology. Therefore, the SFC factors need not be manually set by a user. In addition, the SFC factors can be reliably transmitted, irrespective of header corruption caused by format conversion and transmission of a compressed sound source.

### CROSS-REFERENCE TO RELATED APPLICATIONS

This application claims the priority of Korean Patent Application No. 2004-73367, filed on Sep. 14, 2004 in the Korean Intellectual Property Office, the disclosure of which is incorporated herein in its entirety by reference.

### BACKGROUND OF THE INVENTION

1. Field of the Invention

The present general inventive concept relates to a method of controlling a sound field, and more specifically, to a method of embedding sound field factors and sound field information into a sound source and a method of processing the sound field factors and the sound field information.

2. Description of the Related Art

Conventionally, transmitting sound field information for sound field processing requires a user to directly designate the sound field information. Additionally, the sound field information is typically inserted into a header of a packet having a compressed sound source. The sound field information may also be extracted from a sound source itself.

The user designates the sound field information through an input of an audio device with a sound field processor. This conventional method has a drawback in that the user is required to designate the sound field information, according to characteristics of the sound source. In an attempt to overcome this drawback, a method of matching information about a medium and audio tracks stored thereon with already-input sound field information has been disclosed.

FIG. 1 is a flow chart illustrating a conventional method of controlling a sound field. The method illustrated in FIG. 1 is disclosed in Korean Patent Laid-Open No. 1998-03133 (published Jul. 25, 1998).

The method of controlling the sound field includes an operation S21 of setting and storing sound field information on a CD number or track, an operation S22 of determining whether the CD is playing, an operation S23 of inputting currently playing CD number and track information, an operation S24 of determining whether the sound field information has already been stored, an operation S25 of controlling the sound field based on the sound field information on the given CD and track when the sound field information on the given CD and track has already been stored, an operation S26 of storing the sound field information selected by a user when sound field information on the given CD and track has not been stored, and an operation S27 of controlling the sound field based on sound field information selected by the user.

According to the conventional method of controlling the sound field illustrated in FIG. 1, which is adapted to the CD, the sound field is controlled based on the sound field information that is stored when the CD is initially played. Alternatively, the sound field information can be stored in advance. In this case, the sound field can be controlled based on the stored sound field information when the given CD or track is played.

However, the method of controlling the sound field illustrated in FIG. 1 requires the user to set the sound field information at least once. In addition, even though characteristics of the sound field can vary in parts of the track, the sound field information can only be set for an average of the sound field characteristics throughout the entire track. Thus, this method may be used with media having a segmented sound source recorded thereon,(e.g., files, tracks of music, and music videos). However, this method may not be used with media having a continuous sound source, such as a soap opera or a movie.

Further, when the sound field information is inserted into the header of an audio packet having a compression sound source (e.g., an MPEG compression sound source) the sound field information may be corrupted any time the header is corrupted by transformation such as a format conversion and/or a transmission. In addition, when the sound field information is extracted from the sound source itself, there are problems in that accuracy is not guaranteed, real time processing may not be achieved, and the characteristics of the sound field are significantly different for most types of media. Therefore, this method is difficult to implement.

### SUMMARY OF THE INVENTION

The present general inventive concept provides a method of embedding sound field control (SFC) factors representing characteristics of a sound source and sound field information representing a scene of a program, a genre of the program, and a sound field mode etc., into an uncompressed sound source.

The present general inventive concept also provides a method of processing a sound field according to the method of embedding the SFC factors.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept are achieved by providing a method of embedding sound field control (SFC) factors, the method comprising: coding sound field factors and sound field information to obtain the SFC factors for a sound source in a binary data type, wherein the sound field factors represent an acoustic characteristic of the sound source and the sound field information represents an environment under which the sound source is decoded, and watermarking the SFC factors into the sound source without compressing the sound source.

The SFC factors, which refer to sound field factors and sound field information, may be embedded into the uncompressed sound source using watermarking. The uncompressed sound source may be segmented into a plurality of frames according to a frame unit, and the SFC factors may be included in each frame. In addition, the frame segmenting may be initiated at a position where characteristics of sound field change significantly.

The SFC factors that represent characteristics of the sound source may be embedded into the sound source itself using a digital watermarking technology. Therefore, the user need not manually set the SFC factors one by one. In addition, the SFC factors can be reliably transmitted, irrespective of header corruption caused by format conversion of a compressed sound source and transmission.

The foregoing and/or other aspects and advantages of the present general inventive concept are also achieved by providing a method of processing a sound field, the method comprising: receiving a sound source having watermarked SFC factors, decoding the watermarked SFC factors from the sound source and performing a sound field processing on the sound source based on the decoded SFC factors.

A transitional processing, such as fade-in and fade-out processing, can be performed based on SFC factors in a present frame and other SFC factors in a next frame. Therefore, a sound field processing can be performed with presence.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a flow chart illustrating a conventional method of controlling a sound field;

FIG. 2 is a block diagram illustrating an apparatus to embed sound field control (SFC) factors according to the present general inventive concept;

FIG. 3 illustrates a method of embedding the SFC factors according to the present general inventive concept;

FIG. 4 is a schematic diagram illustrating sound field factors representing acoustic characteristic of a sound source;

FIG. 5 is a schematic diagram illustrating operation of a watermark encoder of the method of embedding the SFC factors of FIG. 3;

FIG. 6 is a schematic diagram illustrating an operation of extracting the SFC factors from the sound source encoded by the watermark encoder of FIG. 5;

FIG. 7 is a schematic diagram illustrating a watermark decoding operation of the operation of extracting the SFC factors of FIG. 6; and

FIG. 8 is a flow chart illustrating a method of embedding SFC factors and processing a sound field according to the present general inventive concept.

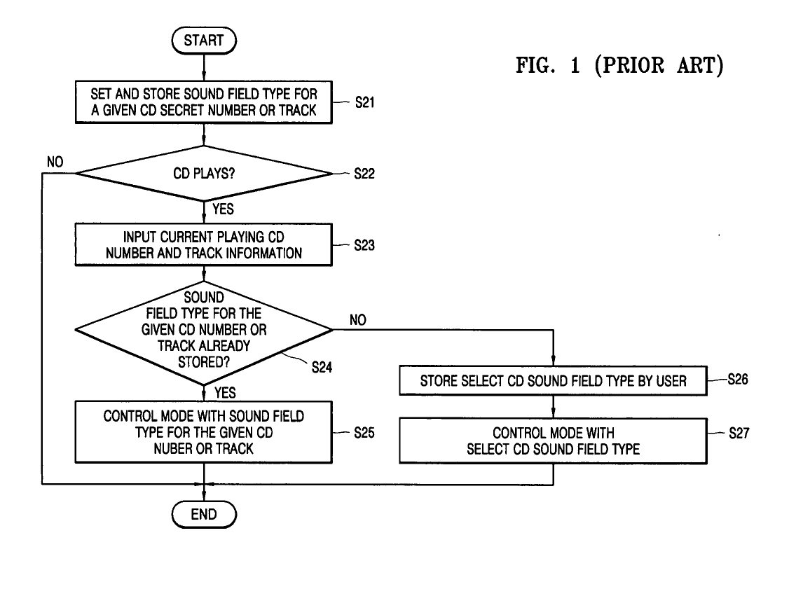

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

The present general inventive concept provides a method of embedding sound field control factors (hereinafter, referred to as ‘SFC factors’) that represent sound field characteristics of an uncompressed sound source using watermarking. The watermarked sound source is able to maintain sound properties thereof even though the SFC factors are embedded therein. In addition, the SFC factors, which are decoded by an extracting method that corresponds to the embedding method, are used to process the sound field.

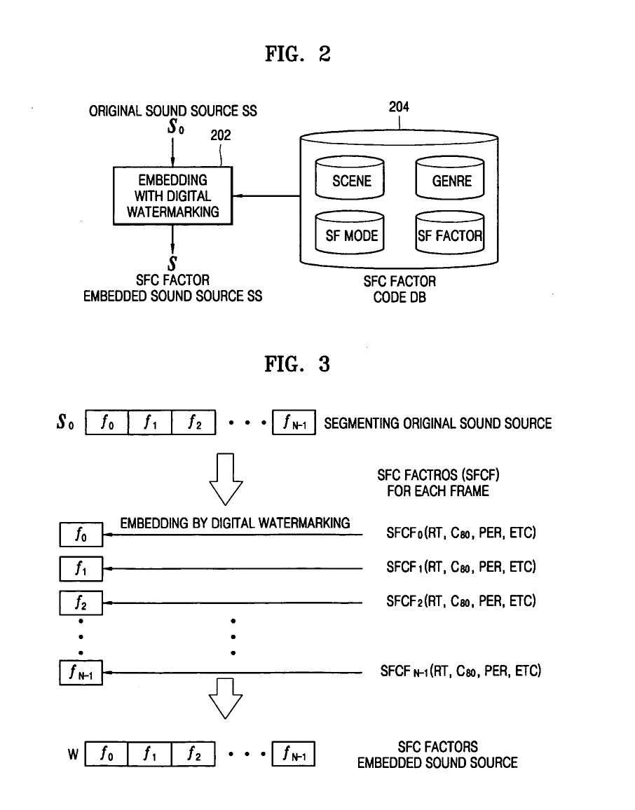

FIG. 2 is a block diagram illustrating an apparatus to embed the SFC factors in the sound source according to the present general inventive concept. The apparatus includes a watermark encoder 202 and an SFC factor database 204. The watermark encoder 202 performs watermarking of an original sound source So with the corresponding SFC factors. The SFC factors refer to coded data embedded with a sound field factor and sound field information. The sound field factor (SF factor) represents an acoustic characteristic of the sound source and includes a reverberation time (RT), a clearness (C), and a pattern of early reflection (PER). Other acoustic characteristics may also be included in the sound field factor. On the other hand, the sound field information includes a program scene, a program genre, and a sound field mode (SF mode) to represent a place where the sound source is recorded, such as woods, plains, caves, or the like.

The SF factor, the SF mode, the program scene, and the program genre are embedded in the sound source So and stored in the SFC factor database 204. The SF factor may be directly extracted from the sound source So signal. The user may designate the SF mode, the program scene, and the program genre at the time that the sound source So is recorded.

FIG. 3 illustrates a method of embedding SFC factors according to the present general inventive concept.

The sound source So is segmented into a plurality of frames. The SFC factors are embedded in the sound source So for each frame. The plurality of frames may be segmented based on a position where the characteristics of the sound field of the sound source So can be clearly distinguished. For example, the plurality of frames may be obtained based on a position where the SF mode, the program scene, or the program genre change or where the SF factor can be noticeably distinguished.

The sound source So is segmented into the plurality of frames including fₒ, f₁, f₂, . . . , and f_{N-1}. For each of the plurality of frames fₒ, f₁, f₂, . . . , and f_{N-1}, corresponding SFC factors SFCF₀, SFCF₁, SFCF₂, . . . , and SFCF_{N-1} are embedded in respective frames of the sound source So.

The SFC factors SFCF, which comprise coded digital information, include corresponding SF factors, such as RT-reverberation time, C₈₀-clearness, and PER-pattern of early reflection, and other sound field information.

As a result of the encoding of the sound source So with the SFC factors SFCF using the watermark encoder 202, the embedded results including f′ₒ, f′₁, f′₂, . . . , f′_{N-1} are obtained.

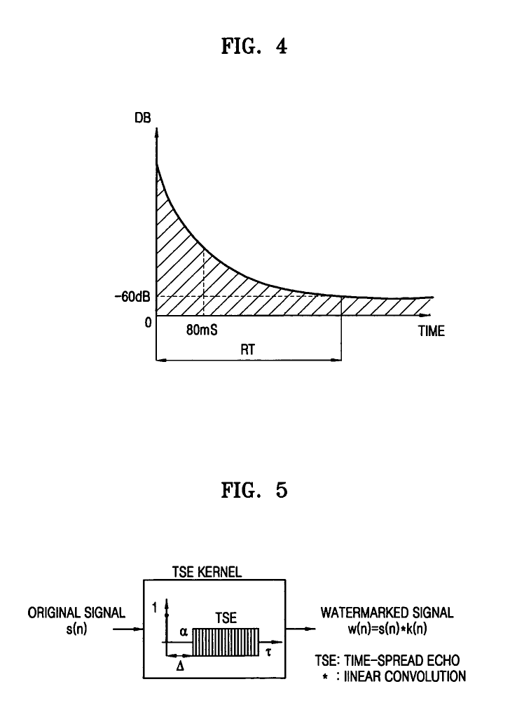

FIG. 4 is a schematic diagram illustrating sound field factors representing acoustic characteristic of the sound source. The reverberation time RT refers to a period over which the strength of a sound falls by 60 dB from an initial strength. The clearness represents a ratio of energies including a first energy from a time a sound is generated to 80 mS and a second energy from 80 mS to a time when the strength of the sound falls by 60 dB. The pattern of early reflection PER refers to a reflection pattern after a sound is generated.

FIG. 5 is a schematic diagram illustrating operation of a watermark encoder of the method of embedding the SFC factors of FIG. 3. In the present general inventive concept, a time-spread echo method may be used to add the SFC factors to the sound source.

A kernel of the time-spread echo method can be represented by the following equation.
k(n)=δ(n)+α·p(n−Δ)
where δ(n) is a dirac-delta function, p(n) is a pseudo-noise (PN) sequence, α is an amplitude, and Δ is a time delay. The time-spread echo method adds different information (binary data) to the sound source by using different time delays Δ or different PN sequence p(n).

In addition, p(n) serves as a secret key or an open key with which the embedded information can be extracted. Therefore, the secret key or the open key type can be used according to a system specification. For example, a key type may depend on controlling access of the embedded information.

Referring to FIG. 5, the watermarked sound source W(n) is represented by the following equation.
W(n)=s(n)*k(n) where * refers to a linear convolution.

FIG. 6 is a schematic diagram illustrating an operation of extracting SFC factors from the sound source encoded by the watermark encoder of FIG. 5.

A present frame fₚᵣₑₛₑₙₜ and a next frame fₙₑₓₜ are decoded through independent decoding processes. Thus, an SFC factor of the present frame SFCFₚᵣₑₛₑₙₜ and an SFC factor of the next frame SFCFₙₑₓₜ are decoded. The sound field processor references the decoded SFC factors.

In the sound field processing, the SFC factors in the present frame are referenced for the processing of the next frame. For example, when the SF mode of the present frame is a cave mode and the SF mode of the next frame is a plain (i.e., an extensive area of land without trees) mode, a fade-out processing is performed to prevent a reverberation sound adapted to the cave SF mode from affecting a reverberation sound adapted to the plain SF mode.

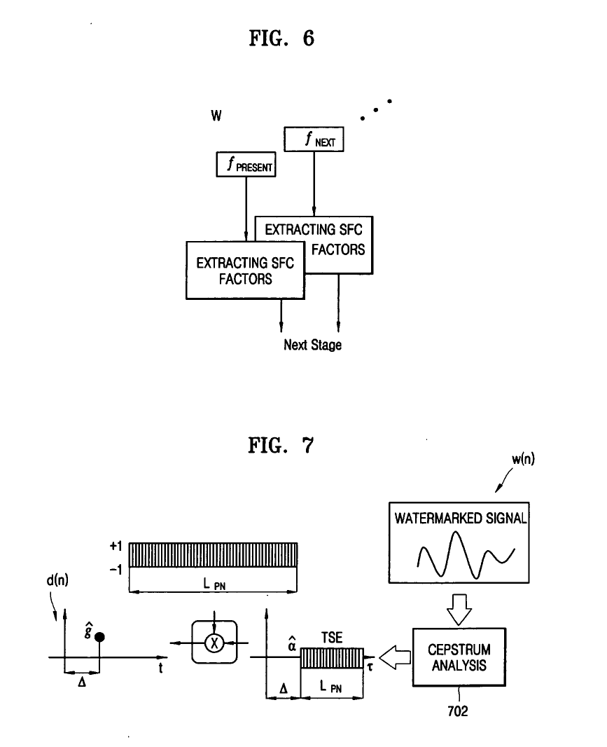

FIG. 7 is a schematic diagram illustrating a watermark-decoding operation of the operation of extracting the SFC factors of FIG. 6.

According to the present general inventive concept, the SFC factors, encoded as illustrated in FIG. 5, are decoded using the time-spread echo (TSE) method. Referring to FIG. 7, a cepstrum analyzer 702 is used to increase the clearness of the watermarked sound source W(n). In the center of FIG. 7, a time-amplitude characteristic α of the watermarked sound source W(n) is illustrated.

The decoded sound source d(n) obtained from operation illustrated in FIG. 7 is represented by the following equation.
d(n)=F⁻¹[log[F[W(n)]]]\textcircled{×}L_{PN}
where F[ ] and F⁻¹[ ] represent a Fourier transform, and an inverse Fourier transform, respectively, log[ ] refers to a logarithmic function, \textcircled{×} refers to a cross-correlation function, and L_{PN} refers to a PN sequence.

The SFC factors are detected by checking a clear peak position of Δ or ĝ from d(n). The cross correlation \textcircled{×} performs a despreading function between the pseudo noise function and the rest of the cepstrum analyzed signal.

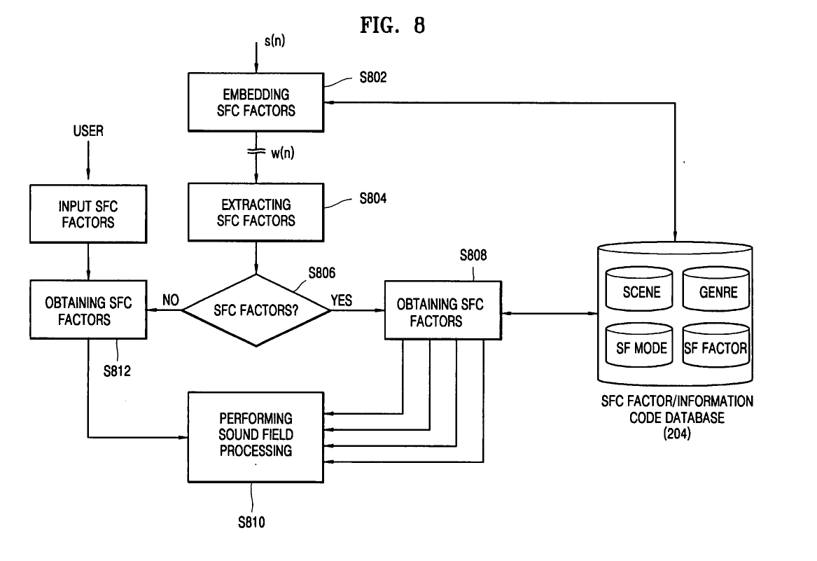

FIG. 8 is a flow chart illustrating a method of embedding SFC factors and processing a sound field according to the present general inventive concept. First, at operation S802, the SFC factors are watermarked and embedded into the sound source. The SFC factors, which are coded data of the sound field factors and the sound field information, are set by referring to the SFC factor database 204 (see FIG. 2). The operation S802 of watermarking the SFC factors is described above with reference to FIGS. 4 and 5.

At operation S804, the SFC factors are decoded from the watermarked sound source. The operation S804 of decoding the SFC factors from the watermarked sound source is described above with reference to FIGS. 6 and 7.

At operation S806, it is determined whether the SFC factors are extracted. If the SFC factors are extracted, at operation S808, the sound field factor and the sound field information that correspond to the embedded SFC factors are obtained by referring to the SFC factor database 204 (see FIG. 2).

At operation S810, the sound field processing is performed by referring to the sound field factor and the sound field information obtained in the operation S808. In performing the sound field processing at the operation S810, sound field processing of the next frame is controlled by referring to the SFC factors of the present frame and the next frame. For example, fade-in and fade-out processing and other transitional processing are performed by referring to the sound field information of the present frame and the next frame. Thus, the sound field processing can be performed with presence.

Further, for the convenience of the user, at the operation 808, both the sound field factor and the sound field information input by the user, as well as the sound field factor and the sound field information obtained from the extraction, can be referred to.

At the operation 806, if the SFC factors are not extracted, the process proceeds to operation S812. At the operation S812, the sound field processing is performed by referring to the sound field factor and the sound field information input by the user.

According to the method of embedding SFC factors of the present general inventive concept, the SFC factors representing characteristics of the sound source are embedded into the sound source itself by using a digital watermarking technology. As a result, the user is not required to designate each of the SFC factors of the sound source.

In addition, according to the method of embedding the SFC factors of the present general inventive concept, the SFC factors are not transmitted in a header of a packet having a compressed sound source. Rather, the SFC factors are embedded and transmitted among sound content in the uncompressed sound source itself using the digital watermark technology. Therefore, even when the header is corrupted by format conversion of the compressed sound source and transmission, the SFC factors can be reliably transmitted.

In addition, according to the method of embedding SFC factors of the present general inventive concept, an uncompressed sound source is segmented into frames. Further, the SFC factors are embedded into each frame of the sound source. Thus, the SFC factors are adapted to the characteristic of the segmented sound source and can be transmitted in real time. In other words, since the sound source may be transmitted in an uncompressed form, the sound source and the SFC factors embedded therein may be processed in real time as the sound source is received by a sound processor. Moreover, the frame segmentation is performed at a position in the sound source where the characteristic of the sound field control is clearly distinguishable. Therefore, the SFC factors can be transmitted more efficiently.

In addition, according to the method of processing the sound field of the present general inventive concept, a transitional processing, such as fade-in and fade-out processing, can be performed based on sound field control (SFC) factors in the present and the next frames. Therefore, the sound field processing can be performed with presence.

As described above, according to the method of embedding SFC factors of the present general inventive concept, the SFC factors representing characteristics of the sound source can be embedded into the sound source itself without degradation in the sound quality, using the digital watermarking technology. In addition, at the time of reproducing the sound source, the SFC factors are extracted and used so that the sound field processing can be reliably performed and the characteristics of sound source can be maintained.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A method of embedding sound field control factors, the method comprising:
coding sound field factors and sound field information to obtain the sound field control factors for a sound source in a binary data type, the sound field factors representing an acoustic characteristic of the sound source and the sound field information representing an environment under which the sound source is recorded; and
watermarking the sound field control factors into the sound source in an uncompressed state.

2. The method according to claim 1, wherein the watermarking of the sound field control factors into the sound source comprises performing a time-spread echo encoding.

3. The method according to claim 2, wherein the sound field control factors are encoded using at least one of a delay time and a pseudo noise sequence.

4. The method according to claim 1, further comprising:
segmenting the uncompressed sound source into a plurality of frames,
wherein the watermarking of the sound field control factors into the sound source comprises encoding the sound field control factors in a frame unit.

5. The method according to claim 4, wherein the segmenting of the uncompressed sound source into the plurality of frames comprises initiating frame segmenting based on a position where sound field information or sound field factors contained in the sound field control factors are significantly changed.

6. The method according to claim 1, wherein the sound source is continuous.

7. The method according to claim 1, further comprising:
transmitting the watermarked sound source in the uncompressed state to a sound processor.

8. A method of processing a sound field, the method comprising:
receiving a sound source having watermarked sound field control factors;
decoding the watermarked sound field control factors from the sound source; and
performing a sound field processing on the sound source based on the decoded sound field control factors.

9. The method according to claim 8, wherein the sound field control factors each comprises a sound field factor that represents an acoustic characteristic of the sound source and sound field information that represents an environment under which the sound source is obtained recorded, and further comprising:
providing the sound field control factors decoded based on a sound field control factor database having sound field control factors and corresponding sound field factors and sound field information; and
representing an environment under which the sound source is obtained according to the decoded sound field control factors.

10. The method according to claim 9, further comprising:
receiving the sound field factor and the sound field information from a user.

11. A method of processing sound, the method comprising:
encoding a sound signal and embedding sound information about at least one sound field of the sound signal in the sound signal in an uncompressed state; and
processing the sound signal and the embedded sound information about the at least one sound field of the sound signal.

12. The method according to claim 11, wherein the sound information about the at least one sound field comprises one or more of a sound field factor, a sound field mode, a program genre, and a program scene.

13. The method according to claim 12, wherein the sound field factor is directly extracted from the sound signal and the sound field mode, the program genre, and the program scene are designated by a user at a time when the sound signal is recorded.

14. The method according to claim 12, wherein the sound field factor comprises one or more of a reverberation time, a clearness, and a pattern of early reflection.

15. The method according to claim 12, wherein the sound field mode represents characteristics of a location of where the sound signal is recorded.

16. The method according to claim 11, wherein the encoding of the sound signal and embedding of the sound information about the at least one sound field of the sound signal comprises segmenting the sound signal into a plurality of frames and embedding corresponding sound information in each of the plurality of frames.

17. The method according to claim 16, wherein the plurality of frames are segmented according to a position in the sound signal where the sound information about at least one sound field of the sound signal changes.

18. The method according to claim 11, wherein the sound information is embedded using a watermarking method performed according to a linear convolution between the sound signal S(n) and a kernel function K(n) of a time spread echo method.

19. The method according to claim 18, wherein the kernel function K(n) is defined by: K(n)=δ(n)+α·p(n−Δ),
where δ(n) represents a dirac delta function, α represents an amplitude, p(n) represents a pseudo-noise sequence, and Δ represents a time delay.

20. The method according to claim 19, wherein p(n) is one of an open key and a secret key to extract the embedded sound information about the at least one sound field of the sound signal from the sound signal.

21. The method according to claim 11, wherein the processing of the sound signal and the embedded sound information about the at least one sound field of the sound signal comprises decoding the embedded sound information about the at least one sound field of the sound signal according to the following:
d(n)=F⁻¹[log[F[W(n)]]]\textcircled{×}L_{PN};
where W(n) represents the sound signal having the embedded sound information, F⁻¹[ ] represents an inverse Fourier transform, F[ ] represents a Fourier transform, log[ ] refers to a logarithmic function, \textcircled{×} refers to a cross-correlation function, and LPN refers to a pseudo noise sequence.

22. The method according to claim 11, wherein the encoding of the sound signal and the embedding of the sound information about the at least one sound field of the sound signal comprises:
mapping the sound information about the at least one sound field to one or more sound field control factors stored in a database; and
embedding the sound signal with the one or more sound field control factors that correspond with the sound information about the at least one sound field of the sound signal.

23. The method according to claim 11, wherein the processing of the sound signal and the embedded sound information about the at least one sound field of the sound signal comprises decoding the sound signal and the embedded sound information about the at least one sound field of the sound signal by independently decoding a plurality of frames of the sound signal including the corresponding sound information embedded therein.

24. The method according to claim 23, wherein the processing of the sound signal and the embedded sound information about the at least one sound field of the sound signal further comprises processing sound information corresponding with a current frame of the sound signal according to a sound field control factor of the current frame and a sound field control factor of a previous frame.

25. The method according to claim 23, wherein the processing of the sound signal and the embedded sound information about the at least one sound field of the sound signal further comprises performing a transitional processing among neighboring ones of the plurality of frames according to the corresponding sound information embedded therein.

26. The method according to claim 25, wherein the transitional processing comprises one or more of a fade in processing and a fade out processing.

27. The method according to claim 24, wherein the transitional processing accounts for changes in a sound field between the neighboring frames.

28. The method according to claim 11, wherein the embedded sound information about the at least one sound field of the sound signal in the sound signal is digitally watermarked in the sound signal.

29. The method according to claim 11, wherein the processing of the sound signal and the embedded sound information about the at least one sound field of the sound signal occurs in real time as the sound signal is received by a sound processor.

30. A method of transmitting information about sound characteristics of a sound source, the method comprising:
storing digital information about sound characteristics of the sound source among sound content of the sound source when the sound source is recorded; and
transmitting the sound source to a sound processor.

31. The method according to claim 30, wherein the digital information about the sound characteristics is watermarked in the sound content of the sound source and the sound content is transmitted in an uncompressed form.

32. The method according to claim 31, wherein the storing of the digital information about sound characteristics of the sound source among the sound content of the sound source comprises dividing the sound content into a plurality of sound frames according to perceived changes in a sound field and storing the digital information about respective sound frames among the plurality of sound frames.

33. The method according to claim 32, further comprising:
receiving the sound source and processing the plurality of sound frames and the stored digital information about the respective sound frames in real time.

34. An apparatus to embed sound field control factors in a sound source, comprising:
a sound field control factor to database to correlate sound field factors and sound field information with the sound field control factors for the sound source in a binary data type, the sound field factors representing an acoustic characteristic of the sound source and the sound field information representing an environment under which the sound source is recorded; and
a watermark encoder to watermark the sound field control factors into the sound source in an uncompressed state.

35. The apparatus according to claim 34, wherein the watermark encoder performs a time-spread echo encoding.

36. The apparatus according to claim 35, wherein the sound field control factors are encoded using at least one of a delay time and a pseudo noise sequence.

37. The apparatus according to claim 35, wherein the watermark encoder watermarks the sound field control factors into the sound source by segmenting the uncompressed sound source into a plurality of frames and encoding the sound field control factors in a frame unit.

38. The apparatus according to claim 37, wherein the watermark encoder segments the uncompressed sound source into the plurality of frames by initiating frame segmenting based on a position where sound field information or sound field factors contained in the sound field control factors are significantly changed.

39. An apparatus to process a sound field, comprising:
a decoder to receive a sound source having watermarked sound field control factors and to decode the watermarked sound field control factors from the sound source; and
a sound processor to process a sound field of the sound source based on the decoded sound field control factors.

40. The apparatus according to claim 39, wherein the sound field control factors each comprises a sound field factor that represents an acoustic characteristic of the sound source and sound field information that represents an environment under which the sound source is obtained; and
the sound processor further provides the sound field control factors decoded based on a sound field control factor database having sound field control factors and corresponding sound field factors and sound field information, and represents an environment under which the sound source is obtained according to the decoded sound field control factors.

41. The apparatus according to claim 40, wherein the sound processor receives the sound field factor and the sound field information from a user.

42. An apparatus to process sound, comprising:
an encoder to embed sound information about at least one sound field of a sound signal in the sound signal in an uncompressed state; and
a sound processor to process the sound signal and the embedded sound information about the at least one sound field of the sound signal.

43. The apparatus according to claim 42, wherein the sound information about the at least one sound field comprises one or more of a sound field factor, a sound field mode, a program genre, and a program scene.

44. The apparatus according to claim 43, wherein the sound field factor is directly extracted from the sound signal and the sound field mode, the program genre, and the program scene are designated by a user at a time when the sound signal is recorded.

45. The apparatus according to claim 43, wherein the sound field factor comprises one or more of a reverberation time, a clearness, and a pattern of early reflection.

46. The apparatus according to claim 43, wherein the sound field mode represents characteristics of a location of where the sound signal is recorded.

47. The apparatus according to claim 42, wherein the encoder encodes the sound signal and embeds the sound information about at least one sound field of the sound signal by segmenting the sound signal into a plurality of frames and embedding corresponding sound information in each of the plurality of frames.

48. The apparatus according to claim 47, wherein the plurality of frames are segmented according to a position in the sound signal where the sound information about at least one sound field of the sound signal changes.

49. The apparatus according to claim 42, wherein the sound signal is embedded using a watermarking method performed by the encoder according to a linear convolution between the sound signal S(n) and a kernel function K(n) of a time spread echo method.

50. The apparatus according to claim 49, wherein the kernel function K(n) is defined by: K(n)=δ(n)+α·p(n−Δ),
where δ(n) represents a dirac delta function, a represents an amplitude, p(n) represents a pseudo-noise sequence, and Δ represents a time delay.

51. The apparatus according to claim 50, wherein p(n) is one of an open key and a secret key to extract the embedded sound information about the at least one sound field of the sound signal from the sound signal.

52. The apparatus according to claim 42, wherein the sound processor decodes the sound signal and the embedded sound information about the at least one sound field of the sound signal according to the following:
d(n)=F⁻¹[log[F[W(n)]]]\textcircled{×}L_{PN};
where W(n) represents the sound signal having the embedded sound information, F⁻¹[ ] represents an inverse Fourier transform, F[ ] represents a Fourier transform, log[ ] refers to a logarithmic function, \textcircled{×} refers to a cross-correlation function, and LPN refers to a pseudo noise sequence.

53. The apparatus according to claim 42, wherein the encoder encodes the sound signal and embeds the sound information about the at least one sound field of the sound signal by mapping the sound information about the at least one sound field to one or more sound field control factors stored in a database, and embedding the sound signal with the one or more sound field control factors that correspond with the sound information about the at least one sound field of the sound signal.

54. The apparatus according to claim 42, wherein the sound processor decodes the sound signal and the embedded sound information about the at least one sound field of the sound signal by independently decoding a plurality of frames of the sound signal including the corresponding sound information embedded therein.

55. The apparatus according to claim 54, wherein the sound processor processes sound information corresponding with a current frame of the sound signal according to a sound field control factor of the current frame and a sound field control factor of a previous frame.

56. The apparatus according to claim 54, wherein the sound processor performs a transitional processing among neighboring ones of the plurality of frames according to the corresponding sound information embedded therein.

57. The apparatus according to claim 56, wherein the transitional processing comprises one or more of a fade in processing and a fade out processing.

58. The apparatus according to claim 56, wherein the transitional processing accounts for changes in a sound field between the neighboring frames.

59. The apparatus according to claim 42, wherein the sound information about the at least one sound field of the sound signal in the sound signal is digitally watermarked in the sound signal.

60. The apparatus according to claim 42, wherein the sound processor processes the sound signal and the embedded sound information about the at least one sound field of the sound signal in real time as the sound signal is received by the sound processor.

61. An apparatus to transmit information about sound characteristics of a sound source, the apparatus comprising:
an encoder to store digital information about sound characteristics of the sound source among sound content of the sound source when the sound source is recorded and to transmit the sound source to a sound processor.

62. The apparatus according to claim 61, wherein the digital information about the sound characteristics is watermarked in the sound content of the sound source and the sound content is transmitted in an uncompressed form.

63. The apparatus according to claim 62, wherein the encoder stores the digital information about sound characteristics of the sound source among the sound content of the sound source by dividing the sound content into a plurality of sound frames according to perceived changes in a sound field and storing the digital information about respective sound frames among the plurality of sound frames.

64. The apparatus according to claim 63, further comprising:
a sound processor to receiving the sound source and to process the plurality of sound frames and the stored digital information about the respective sound frames in real time.
